(19) United States
(12) Patent Application Publication
(10) Pub. No.: US 2013/0295977 A1
(43) Pub. Date: Nov. 7, 2013

(54) AUTOMATIC CONFIGURATION OF A SYSTEM COMPRISING MOVABLE RF DEVICES

(71) Applicants: Philippe Salamitou, Boileau (FR); Damien Rougeux, Boileau (FR)

(72) Inventors: Philippe Salamitou, Boileau (FR); Damien Rougeux, Boileau (FR)

(21) Appl. No.: 12/598,211

(22) PCT Filed: Apr. 30, 2008
(86) PCT No.: PCT/FR08/50781

§ 371 Date: Mar. 29, 2010

(30) Foreign Application Priority Data
Apr. 30, 2007 (FR) FR0754808

(51) Int. Cl. H04B 7/26

(52) U.S. Cl. CPC H04B 7/2603
USPC 455/507

(57) ABSTRACT

A radiofrequency communication system (10) comprises RF electronic devices (22) equipped with resources, and a computer system (24) equipped with a frontier controller (28) capable of communicating with said devices (22). The memory of a device in a given class comprises the specification specific to this class. The specification specifies the resources and the operations that can be carried out by the devices in the class concerned. The specification is communicated to the frontier controller and is propagated in the computer system. An automatic configuration of the computer system is carried out which takes account of the resources and the operations which can be carried out by the devices of the class concerned.

### TECHNICAL FIELD

This invention relates to a method for automatic configuration of a system comprising movable devices communicating by radiofrequency (RF) with a computer system. The invention also relates to a radiofrequency communication system to monitor movable objects.

### STATE OF THE PRIOR ART

RF devices are generally associated with objects (equipment or products) for various applications, such as identification of objects, logistics, quality control, monitoring and preventive maintenance of these objects. In simple terms, an RF device is part of a communication network which includes an RF terminal equipped with a controller (hereafter referred to as the “frontier controller”) which manages communication by radio waves with a plurality of RF devices and a terminal or server composed of at least a computer connected by wired or wireless link with the RF terminal. The terminal communicates with the RF terminal and saves and processes data exchanged between the frontier controller and the RF devices.

The movable RF devices comprise resources (e.g. an energy source such as a battery, a microcontroller, a memory, computation power, input/output ports possibly connected to sensors and/or actuators, etc.) and can perform operations (read/write memory, computations, acquisition of sensors, etc.). Identical objects may be associated with identical RF devices, therefore of the same type or “class”. “Identical RF devices of the same class” are taken to mean RF devices with the same resources and which can perform the same operations. Their specifications, which describe these resources and these operations, are therefore identical. The structure and operation of the RF devices are optimized for each object class. Generally therefore, the RF devices are neither identical nor compatible with each other: their specifications are therefore different. The RF devices have other limitations:
the embedded computation power of the devices is low compared with that of the associated computer system;
the RF devices are often in standby mode (e.g. 99% of the time) and may only perform a limited number of operations, intermittently;
RF communication has a reduced bandwidth (e.g. about 50 kps) compared with the associated computer system (typically in the region of 1 Mbps);
RF communication induces high energy consumption for the embedded devices (about 20 mA, to be compared with the capacity of a 2 Ah battery).

The objective of this invention is to allow optimum operation of the resources of the movable devices. Consequently, the tasks to be accomplished (which define an operation process) to operate the RF devices with the computer system and to acquire and process data from the RF devices, are transferred to the computer system which is much more powerful in terms of computation possibilities and memory than the RF devices, the latter, then performing only simple operations, triggered by clock, or by simplified commands received via the RF communication.

The problem which arises and which is solved by this invention is that, in order to transfer said tasks to the computer system to operate the RF devices, the computer system and the manager must know the specification of these RF devices, i.e. know their resources and the operations they can perform.

One known solution consists in using only identical RF devices, which amounts to standardizing the specification of these devices. In this case, the frontier controller only operates for a single class of RF devices. However, this solution does not allow heterogeneous RF devices to be introduced into the system.

According to another known solution, the specifications are saved in files characteristic of each class of devices. These files are distributed to the various computer systems likely to come into contact with the RF devices. The files are used to adapt the program executed by the frontier controller to the various specifications of the devices. For example, in the field of SCADA (Supervisory Control And Data Acquisition) type fixed industrial monitoring systems using the HART® protocol, various types of monitoring device (e.g. sensors) are recognized and operated by the computer system via a file storing the various configuration elements. It is generally provided to the network components by manual configuration. While this configuration mode does not create problems for the fixed systems (such as SCADA) or systems which move very little, it is unsuitable for movable devices. A CD-ROM containing a library of the existing devices is supplied by the HART Communication Foundation. This solution is described at the following web site: http://www.hartcomm.org/technical/dd_library/about_ddl.html

The major disadvantage of this solution (distribution, “a priori”, of the class specification) is the complexity of the method since the specifications of all device classes in circulation must be systematically distributed to all computer systems likely to come into contact with them. The problem is worse if the devices are movable and therefore likely to come into contact with numerous different computer systems.

According to another solution, described for example in U.S. Pat. No. 6,615,038, the class specifications are stored in a server, which is called by the elements of the computer system whenever necessary. This solution is especially suited to cell telephony since there is a limited number of operators. The telephone manufacturers can in fact guarantee the operators access to a suitable server. In addition, the computer system of a telephony operator is perfectly connected. However, this solution is not suitable when the computer system is not connected to the world wide web www (e.g. when a frontier controller is only connected to one terminal).

### DESCRIPTION OF THE INVENTION

This invention proposes a method for automatic configuration of a system comprising movable RF devices. According to the invention, the class specification of an RF device is stored, statically, in the memory of the RF device. The class specification is not used by the device itself, which does not necessarily has the resources required to interpret it.

More precisely, the invention relates to a method for automatic configuration of a radiofrequency (RF) communication system comprising:
RF devices, each one being associated with a movable object and equipped with resources comprising at least a microcontroller, a memory and a radiofrequency communication circuit, the memory comprising a class specification specifying the resources and the operations which can be performed by the RF device concerned, said operations being specified as logic instructions allowing use of said resources by said computer system, and
a computer system comprising at least a communication terminal equipped with a frontier controller to communicate with said RF devices,

the method comprising:
a detection step, wherein the frontier controller sets up communication with an RF device belonging to a class previously unknown to the communication system, and
a declaration step, wherein said RF device communicates the class specification present in its memory to said frontier controller.

Said class specification is advantageously propagated in the computer system from said frontier controller.

Advantageously, the class specification comprises “business” elements understandable by a manager of the computer system and logic elements understandable by the RF devices in a given class, the “business” and logic elements describing the resources, the operations and the parameters of said operations.

Said manager may be a physical person or a computer program controlling the system and/or processing the data.

An operating program specification to use RF devices in a given class is advantageously created by the manager of the computer system, for each class, from said “business” elements and an operating specification from the manager.

Preferably, said operating program description is converted by a program generator, using said class specification, into an operating program to use the resources of the RF devices in the class concerned. The operating program can execute operations in the RF devices, the command and the result of these operations being transmitted by RF link. The operating program can be executed by said computer system, especially by said frontier controllers.

Advantageously, said class specification and said operating program specification are in XML file format.

The invention also relates to a radiofrequency RF communication system to monitor movable objects, the communication system comprising:
RF devices, each one being associated with one of said movable objects, the RF devices being equipped with resources including at least a memory and at least a processor to perform operations, and equipped with a radiofrequency communication circuit, and
a computer system comprising at least a communication terminal equipped with a frontier controller to communicate with the RF devices.

According to the invention, said at least one memory of an RF device comprises a class specification specifying said resources and said operations, said operations being specified as logic instructions allowing use of said resources by said computer system.

According to a first embodiment, the computer system comprises a manager interface allowing a manager to establish an operating program definition to use the resources of the RF devices in a given class. The operating program definition is established from said class specification and an operating specification from the manager.

Said manager interface preferably comprises:
a parser to analyze the class specification in order to supply a description of the resources of the RF devices in the class concerned in manager language,
a formatter to format said operating program definition, in order to supply an operating program specification.

According to the first embodiment, the system comprises a program generator comprising a first parser to analyze said operating program specification and a second parser to analyze said specification of said class, and a transformation program to deliver an operating program from the analysis results of said parsers.

Since the RF devices are not all identical, each belonging to a given class corresponding to a particular specification, the class specification of an RF device preferably indicates the class to which the RF device belongs.

The invention also relates to a computer program product for a processor in a radiofrequency communication system, the computer program product comprising a set of instructions which, being executed by the processor, causes the processor to perform the method described above.

The invention applies in particular to monitoring of a set of gas bottles each equipped with a pressure sensor.

### BRIEF DESCRIPTION OF THE DRAWINGS

Other advantages and features of the invention will appear on reading the description which follows of several embodiments of the invention given as non-limiting examples, in reference to the attached drawings, on which:

FIG. 1 shows a communication system, for which implementation of the method of the invention is extremely suitable,

FIG. 2 is a diagrammatic representation of a class specification transmission process,

FIG. 3 represents various steps of the method,

FIG. 4 is a diagrammatic representation of an embodiment of the mechanism for creation of a process to operate the RF devices, and

FIG. 5 is a diagram describing an example of a mechanism allowing a computer system to control RF devices of a new class.

### EMBODIMENTS OF THE INVENTION

FIG. 1 illustrates an RF communication system 10 intended to monitor movable objects 12 and for which the method of the invention can advantageously be implemented. These objects may be different from each other: for example, containers 14 loaded on a lorry, various objects 16 moving on a conveyor 18, or crates 20. An RF device 22 is attached to each object. The identical objects can be associated with identical RF devices thereby forming a class of devices. In this case, there is one class for each different object. Each RF device 22 has its own resources (for example an energy source such as a battery, a microcontroller, a memory, computation power, input/output ports, possibly connected to sensors). The RF device of a movable object 12 communicates with a fixed computer system 24 when presence of an object is detected by a radio communication terminal 26 equipped with a frontier controller 28 (therefore when the object comes within the radio communication field of a terminal 26). The terminals may take various shapes represented on FIG. 1, such as antennas or portals with more or less powerful computer means and RF communication circuits. Communication by radiofrequency waves between the RF devices 22 and the terminals 26 may be RFID type for example. The terminals 26 are connected to RF readers and to one or more databases 30, centralizing the data received from the RF devices, the databases being connected to at least one terminal 32, such as a computer, portable or fixed, or a mobile telephone provided to a user. This type of communication system is for example described in the international patent application published under number WO 2007/074246 filed by the applicant and included here for reference.

This type of system 10 can be used to monitor objects 12 or at least one of their characteristics, to take an inventory, for example, or to check a characteristic of these objects which may be equipped with sensors, such as a pressure or temperature sensor. Whenever an object comes within the RF detection radius of a reading terminal, the terminal communicates with the RF device associated with the object in order to read data stored in the memory of the RF device. In order to set up this communication and so that the data stored in the memory of the RF devices is meaningful to the fixed computer system 24, the exchanges between the RF devices 22 and the computer system 24 must be configured in the read terminals 26, the databases 30 and the terminals 32. This type of configuration may be necessary if for example, the computer system was not initially programmed for this type of monitoring, if the object characteristics have been changed, or if objects of a new type for the system have been added.

According to the invention, a class specification of the RF device 22 is stored in the memory of the device. Devices in a given class have the same resources and can perform the same operations. They therefore have the same class specification, specifying resources of the class of RF devices, logic instructions and their parameters so that the computer system can use these resources. The class specification is stored statically in the memory of the RF device 22. It is not used by the RF device itself, which does not necessarily has the resources required to interpret it. When the frontier controller 28 of a terminal 26 receives a message from a device of a class which is not known by the computer system it belongs to, the device downloads its class specification via the RF link.

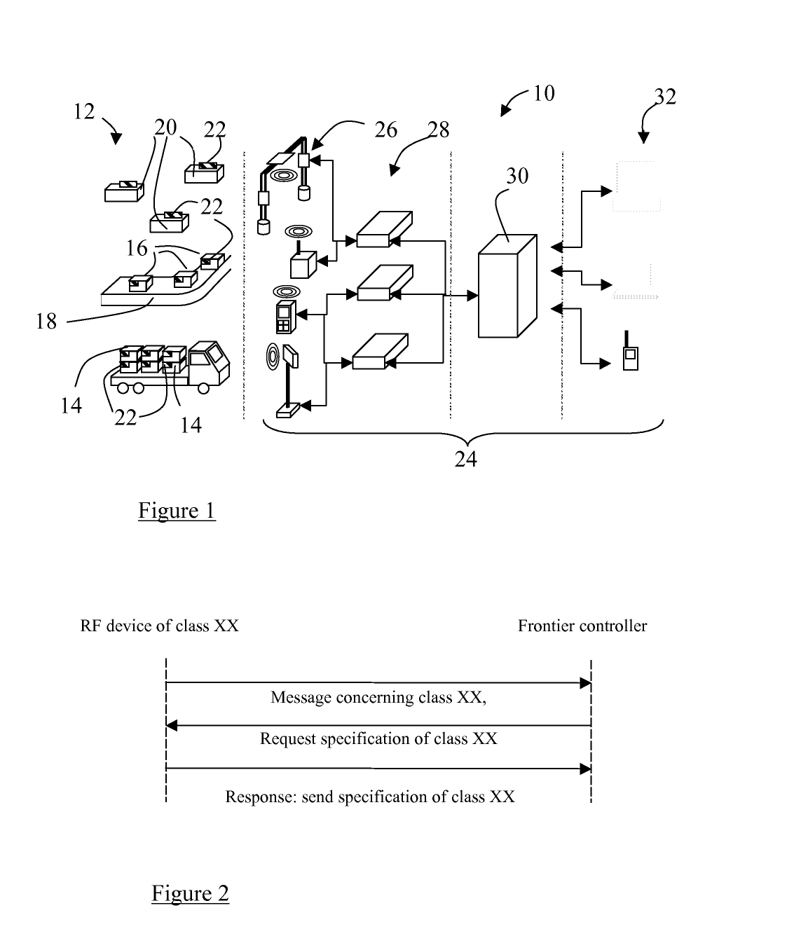

FIG. 2 illustrates the class specification transmission process: when an RF device 22 of a class XX sends a message to the frontier controller of a terminal 26 which does not know this class, the controller then sends to the device 22 a request to find the specification of this class XX. The RF device replies by sending the specification of this class, the specification including the description of the resources of the RF devices in this class and the list of the operations (as logic instructions), and their parameters, to allow use of the resources by the computer system, that these devices are capable of performing. Note that in the event of a first connection, the connection mode of the device and the computer system is independent of the device class. During this connection, the device declares its class XX to the frontier controller.

The resources included in a class specification may concern the following elements of RF devices, given as examples: one or more sensors, e.g. pressure and/or temperature sensors; RF communication; static memory ranges storing information intended for the manager; dynamic memory ranges storing the history of values of the sensor(s); an actuator, such as a valve or relay; the clock; a display; an algorithm; a configuration parameter (calibration, wake-up and transmission period, wake-up mechanism, etc.); encryption of the communication; storage of a list of users and their passwords; the wire link to a peripheral device.

The following list provides examples of operations which can be described in a class specification: triggering acquisition of data from a sensor; triggering an actuator; writing a memory range from data transmitted by RF; reading a memory range and transmission of this range by RF; displaying a message on a display; resetting the clock; launching a computation.

The class specification contains “business” elements and logic elements. It forms the link between these elements. The “business” elements describe the resources and the operations (typically as described above) so that they can be understood by a manager of the system 10. The business elements can be understood by the manager, but do not concern the details (e.g. a business element may be the word sensor, without further details). For example, business declarations may be:
for declaration of resources: e.g.: display, actuator, or a memory range in which data is stored.
for declaration of the operations associated with these resources: e.g.: display, actuate or read/write in the memory range.

The logic elements describe the same resources and operations, but in logic terms, in a format which includes the RF device and the computer system (e.g.: resource identifiers and addresses, data format, structure and configuration of the commands triggering execution of operations, etc.). These logic elements include logic instructions, formats and parameters allowing the RF device resources to be used. For example, logic elements may be:
the physical addresses and logic identification numbers of the resources in the RF device: e.g.: sensor identifier, address and size of a memory range.
the format and configuration of the commands exchanged between the computer system and the RF devices to allow use: for example, a display command starts with the letter D and is followed by the string of characters to be displayed.
the format and configuration of the data exchanges between the computer system and the RF devices to allow use: for example, the data of a pressure sensor is supplied as floating point numbers.

The class specification can be stored as a text file, advantageously in XML format, since with this format a field can be added if necessary without having to modify the existing specifications. The following examples are specification examples referring to resources and operations concerning a system for monitoring gas bottles each equipped with an RF communication device and a pressure sensor (the specification elements are on the left and the comments are on the right indicated by the characters //):
Elements of the Specification File Concerning a Sensor Type Resource:

| <sen id=“Pressure 001” num=“1 > | | //resource identifier, |
|---|---|---|
| | | pressure sensor logic number |
| | <lbl>Bottle pressure</lbl>//sensor name, which will be displayed | |
| | <dat uni=“psi” typ=“flo” ></dat> | // description of the data |

supplied by

the sensor (PSI user unit, data logic format
“float”

| | |
|---|---|
| <min>0</min> | // sensor minimum value |
| <max>140</max> | // sensor maximum value |

Specification Element Concerning a Memory Field Resource for Data Storage:

| | |
|---|---|
| <fie id=“Field 001” adr=“1400” > | // memory field identifier and logic |

address

<lbl>Owner's name</lbl> //memory field name, which will be

displayed

| | |
|---|---|
| <dat typ=“str” len=“20”></dat> | // description of the type of data |
| | stored: (string of maximum 20 |
| | characters). |

Specification Element of an Operation Triggering Display of a Message on a Screen Associated with the RF Device:

<ope id=“Displays 001” hea=“D” >// operation identifier, at the start of

| | |
|---|---|
| | the logic command corresponding to |
| | the operation and which is recognized |
| | by the RF device |
| <lbl>Display</lbl> | //operation name, which will be |

displayed

| | |
|---|---|
| <usr len=“20”></usr> | // logic command argument (e.g. |
| | characteristic string entered by the |
| | user, maximum length 20 characters) |

Specification Element Concerning an Operation Triggering Acquisition of Data from a Sensor:

| | |
|---|---|
| <ope id=“002” hea=“A” > | // operation identifier, at the start of |
| | the logic command corresponding to |
| | the operation and which is recognized |
| | by the RF device |
| <lbl>Triggers acquisition</lbl> | //operation name, which will be |

displayed

| | |
|---|---|
| <sen></sen> | // logic command argument |

(sensor identity)

The RF device resource manager may be a physical person or a computer program controlling the system and/or processing the data.

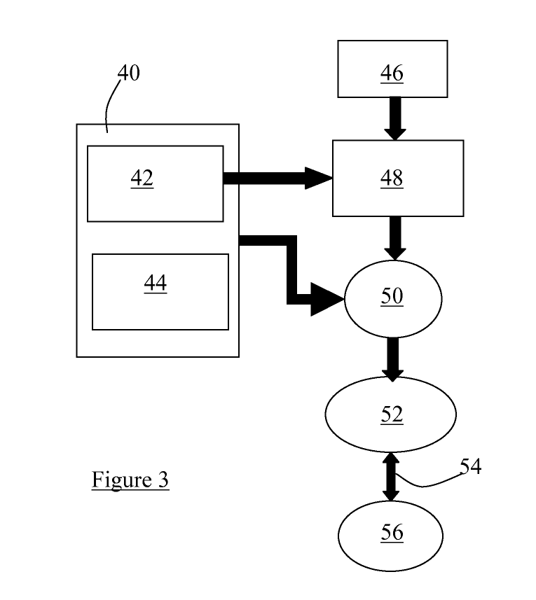

FIG. 3 illustrates a method to process a class specification 40 comprising “business” elements 42 and logic elements 44. Using the “business” elements” 42 of the class specification and its intentions 46, the manager creates (reference 48) an operating program specification to use an RF device. This operating program specification may have the same format as the RF device class specification (e.g. XML file format). Using the business 42 and logic 44 elements of the RF device class specification and using the specification of the operating program 48, a transformation program 50 generates the operating program. This operating program will be executed by the frontier controller 52 which communicates by radiofrequency (arrow 54) with an RF device 56. This operating program is the translation, in logic terms understandable by the RF device 56, of the specification of the operating program 48. The operating program manages in particular RF communications between the device 56 and the frontier controller 52, communications which in turn launch processes in the RF devices.

The operating program launched by the frontier controller can be used, for example, to:
start periodic acquisition of data from a sensor by the RF device, display this data on a screen of the RF device, transmit it to the frontier controller and/or store it in the embedded memory of the device;
read information stored in the memory of the RF device and send it by e-mail to a recipient whose address has been read in the memory of the RF device;
start a servo-controlled process carried out by the RF device combining sensor and actuator.

The operating program can be created, as shown on FIG. 3, using software stored in the frontier controllers.

If necessary, a class specification can be communicated to an element (e.g. a database or a terminal) of the computer system which needs to know this specification. To do this, when a frontier controller detects a device of a new class, it can download its specification. When communicating with another element belonging to its computer system, the frontier controller notifies to this element the presence of a device of a new class, the element can then download the specification from the memory of the frontier controller. A manager can then activate generation of a new operating program which will be run by one or more frontier controllers, which will use the resources of the RF devices in the new class. The specification of a new class is therefore propagated by the frontier controller.

Note that the operating program executed by the frontier controller is created by exchanging the class specification of the RF device. However, the latter does not use the class specification directly.

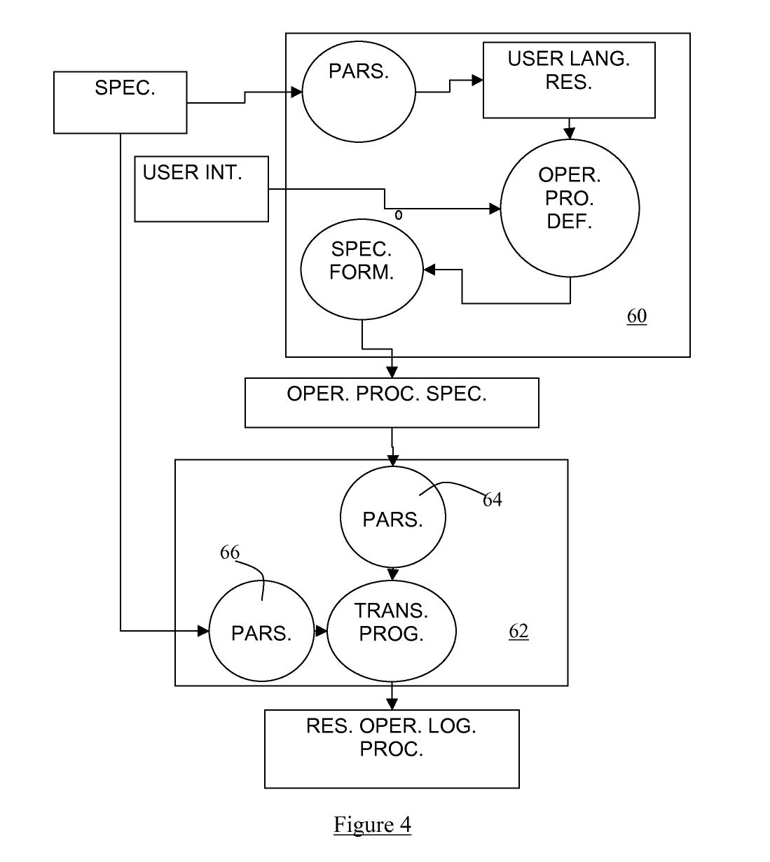

FIG. 4 illustrates one embodiment of a mechanism for creating an operating program to use RF devices from a class specification. The mechanism involves at least two types of computer element: a manager interface 60 and a program generator 62.

The manager interface 60 allows the computer system to declare the resources of an RF device class to the manager. This declaration is carried out by communicating the class specification SPEC. to the manager interface. The manager interface also allows the manager to define (OPER. PROC. DEF.), and therefore to indicate to the computer system, how it wants to use the resources of the RF device. This is carried out by creating an operating program specification (OPER. PROC. SPEC.) delivered by the interface 60. The class specification SPEC. and the description of the operating program OPER. PROC. SPEC. are described in a format facilitating automated exchange of contents within a heterogeneous computer system. Use of XML format is extremely suitable. The manager interface can be a graphic interface if the manager is a physical person.

In the example shown on FIG. 4, the class specification (SPEC.) is analyzed, in business terms, using a parser (PARS.), by a syntax analysis program. The declarations of the RF device resources in manager language (business language), (RES. LANG. USED), are sent to the manager. The manager defines the operating program (OPER. PROC. DEF.) it wants to run. This operating program definition is formatted (FORM. SPEC.) to comply with the chosen exchange format (e.g. XML format). Once created, the operating program specification (OPER. PROC. SPEC.) is sent to the program generator 62, for example via the computer system.

The program generator creates an operating program to use the resources (RES. OPER. LOG. PRO.) of the RF devices in the specified class, from the class specification (SPEC.) and the operating program specification (LOG. PROC. SPEC.). Once created, the operating program (RES. OPER. LOG. PRO.) is run by the computer system. Part of this operating program is used in particular by the frontier controllers which manage the RF communications.

On FIG. 4, the program generator 62 accepts in input the class specification (SPEC.) and the associated operating program specification (OPER. PROC. SPEC.). The latter element is analyzed by a first parser (PARS.) 64 while a second parser (PARS.) 66 performs a syntax analysis on the class specification (SPEC.). After analysis, these two elements are sent to a transformation program (TRANSF. PROG.). This program transforms the operating program specification (OPER. PROG. SPEC.) into an operating program to use the resources of the RF devices in the class considered (RES. OPER. LOG. PROC.), executable by the computer system. This operating program can activate various elements of the computer system, at least the frontier controllers responsible for radio communications to the RF devices.

The manager interface 60 and the program generator 62 can be physically located in different parts of the computer system. There may be one program generator for each element of the computer system concerned by the operating process. The program generators 62 may be located in the elements of the computer system implemented to execute the operating program, especially in the frontier controllers.

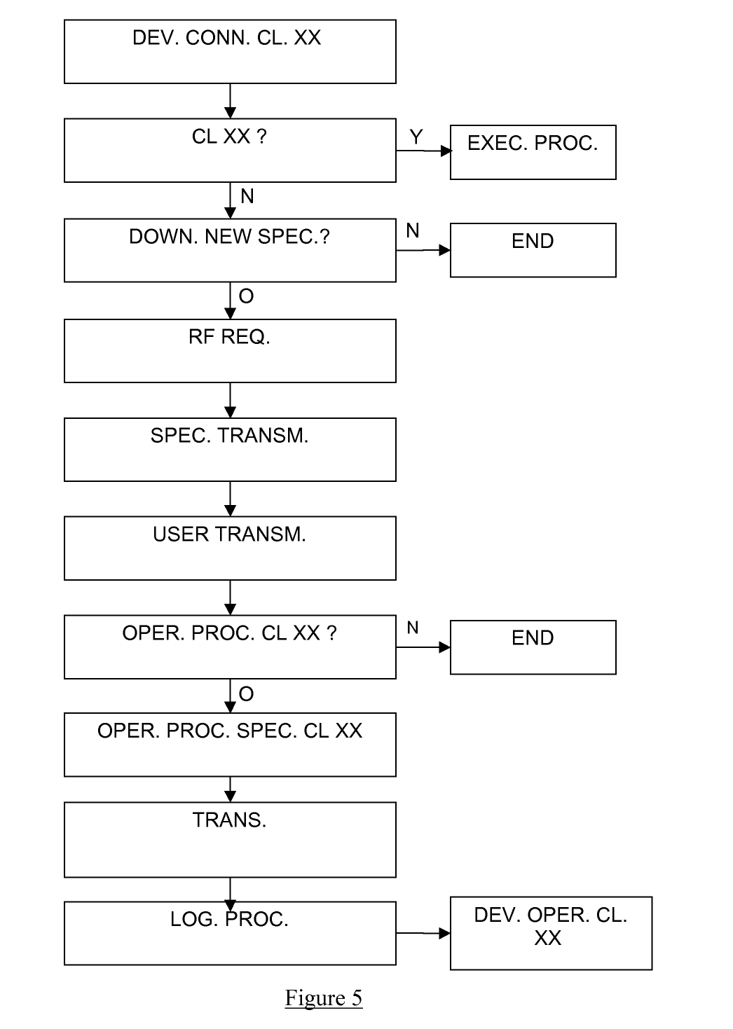

FIG. 5 is a diagram illustrating the various steps implemented by a computer system to use the resources of a new class of RF devices. The operating steps are as follows:
A frontier controller of a computer system sets up a connection with an RF device in class XX (DEV. CONN. CL XX). This first connection assumes that the connection mode of the device and the computer system is independent of the device class. During this connection, the device declares its class XX to the frontier controller.
If an operating program is in progress for this class XX (CL XX ? and positive response Y), the operating program is executed (PROC. EXEC.).

If this is not the case (negative response N), then:
is the frontier controller configured to download new class specifications (DOWN. NEW. SPEC.?)? If the response is negative (N), the mechanism stops (END).
If the frontier controller is configured to download new class specifications (positive response Y), it issues a request (RF REQ.) to the device via radio to download the class specification of the device.
The device transmits its specification (SPEC. TRANSM.) of class XX.
The frontier controller transmits the specification of class XX to the manager (USER TRANSM.).
If the manager does not want (negative response N) to create an operating program for class XX (OPER. PROC. CL XX?), the mechanism stops (END).
Otherwise (positive response Y), the manager creates the operating program specification for the devices in class XX (OPER. PROC. SPEC. CL XX).
The manager transmits (TRANSM.) the operating program specification and the specification of class XX to the program generators concerned by the operating program.
The program generators generate (LOG. PROC.) the operating program of class XX.
The operating program of class XX of the RF devices in class XX is initiated (DEV. OPER. CL XX). This operating program may consist of various routines executed by various elements of the computer system.

The method and system described are extremely suitable for the monitoring of gas bottles equipped with sensors, such as a pressure and/or temperature sensor. This type of object travels extensively, moving from one warehouse to another. Performing its inventory and maintenance automatically is considerably simplified by implementation of this invention.

Embodiments other than those described and represented can be designed by those skilled in the art, without leaving the scope of this invention.

1. Method for automatic configuration of a radiofrequency (RF) communication system (10) comprising:
RF devices (22), each one being associated with a movable object (14, 16, 20) and equipped with resources comprising at least a microcontroller, a memory and a radiofrequency communication circuit, the memory comprising a class specification specifying the resources and the operations which can be performed by the RF device concerned, said operations being specified as logic instructions allowing operation of said resources by said computer system, and
a computer system (24) comprising at least a communication terminal (26) equipped with a frontier controller (28) to communicate with said RF devices (22),
the method comprising:
a detection step, wherein the frontier controller sets up communication with an RF device belonging to a class previously unknown to the communication system, and
a declaration step, wherein said RF device communicates the class specification present in its memory to said frontier controller.

2. Method according to claim 1, characterized in that said class specification is propagated in the computer system from said frontier controller.

3. Method according to claim 1 or 2, characterized in that said class specification (40) comprises “business” elements (42) understandable by a manager of the computer system and logic elements (44) understandable by the RF devices (56) in a given class, said “business” and logic elements describing said resources, said operations and the parameters of said operations.

4. Method according to one of the preceding claims, characterized in that the computer system manager establishes a specification of an operating program (48) to use the resources of the RF devices in a given class, from said “business” elements (42) and an operating specification from the manager.

5. Method according to claim 4, characterized in that said manager is a physical person.

6. Method according to claim 4, characterized in that said manager is a computer manager controlling the system and/or processing the data.

7. Method according to one of claims 4 to 6, characterized in that said specification of the operating program (48) is converted by a conversion program (50), using said class specification (50), into an operating program to use the resources of the RF devices in the given class.

8. Method according to claim 7, characterized in that said operating program is communicated by RF link (54) to said RF devices (56) by said frontier controller (52), said operating program being run by said computer system.

9. Method according to claim 8, characterized in that said operating program is at least partially executed by at least one frontier controller.

10. Method according to one of the preceding claims, characterized in that said class specification (40) and said specification of the operating program (48) are in XML format.

11. Radiofrequency RF communication system (10) for monitoring of movable objects (14, 16, 20), the communication system comprising:
RF devices (22), each one being associated with one of said movable objects, the RF devices being equipped with resources including at least a memory and at least a processor to perform operations, and equipped with a radiofrequency communication circuit, and
a computer system (24) comprising at least a communication terminal (26) equipped with a frontier controller (28) to communicate with the RF devices,
the communication system being characterized in that said at least one memory of an RF device comprises a class specification (40) specifying said resources and said operations, said operations being specified as logic instructions allowing use of said resources by said computer system.

12. Communication system according to claim 11, characterized in that said computer system comprises a manager interface (60) allowing a manager to establish an operating program definition (OPER. PROC. DEF.) to use the resources of said RF devices in a given class, the operating program definition being established from said class specification (SPEC.) and an operating specification from the manager (USER INT.).

13. Communication system according to claim 12, characterized in that said manager interface (60) comprises:
a parser (PARS) to analyze the class specification (SPEC.) in order to supply a description of the resources of the RF devices in the class concerned in manager language (USER LANG. RES.),
a formatter (SPEC. FORM.) to format said operating program definition, in order to supply an operating program specification (OPER. PROC. SPEC.).

14. Communication system according to claim 13, characterized in that it includes a program generator (62) comprising:
a first parser (64) to analyze said operating program specification (OPER. PROC. SPEC.),
a second parser (66) to analyze said class specification (SPEC.), and
a transformation program (TRANSF. PROG.) to deliver an operating program (RES. OPER. LOG PROC.) from the analysis results of said parsers.

15. Communication system according to claim 11 or 14, characterized in that, since the RF devices are not all identical in terms of resources, each belonging to a given class corresponding to a particular class specification, the class specification of an RF device indicating the class to which the RF device belongs.

16. Application of the method defined in one of claims 1 to 10 and of the communication system defined in one of claims 11 to 15, to monitoring of a set of gas bottles each equipped with a pressure sensor.

17. RF device (22) for a communication system according to claim 11, the RF device (22) comprising:
resources, including at least a memory, and at least a processor to perform operations, and
a circuit for communication with a computer system (24) by radiofrequency,
characterized in that said memory of the RF device comprises:
a class specification (40) specifying said resources and said operations, said operations being specified as logic instructions allowing use of said resources by said computer system.

18. Computer program product for a processor in a radiofrequency communication system (10), the computer program product comprising a set of instructions which, being executed by the processor, causes the processor to perform the method defined in one of claims 1 to 10.
